(19) United States
(12) Patent Application Publication
(10) Pub. No.: US 2019/0389277 A1
(43) Pub. Date: Dec. 26, 2019

(54) AIR EXTRACTOR MANUFACTURING METHOD AND ASSEMBLY

(71) Applicant: Ford Global Technologies, LLC, Dearborn, MI (US)

(72) Inventors: David Wade, Plymouth, MI (US); Michael McElroy, South Lyon, MI (US)

(21) Appl. No.: 16/015,855

(22) Filed: Jun. 22, 2018

(51) Int. Cl. B60H 1/24; B29C 45/16

(52) U.S. Cl. CPC B60H 1/249; B29K 2023/12; B29C 45/1676

(57) ABSTRACT

An air extractor manufacturing method includes, among other things, molding at least one flap in a sealed position against a housing of an air extractor. The housing has a first material composition and the at least one flap has a second, different material composition. An air extractor assembly includes, among other things, a housing having a first material composition; and a flap having a different, second material composition. The flap is moveable relative to the housing between a sealed position and a pressure releasing position. The flap is molded in the sealed position and coupled to the housing when molded.

### TECHNICAL FIELD

This disclosure relates to an air extractor for a vehicle and a method of manufacturing the air extractor.

### BACKGROUND

Vehicles can include an air extractor. Flow can move through an opening in the air extractor, as required, to balance a pressure inside the vehicle with a pressure outside the vehicle. The air extractor can be located, for example, behind a bumper at a rear of the vehicle.

The air extractor can include flaps moveable between positions that permit flow through the opening and positions that block flow through the opening. The flaps can block contaminants, such as dust and exhaust gases, from moving through the opening when flow is not moving through the air extractor to balance the pressure.

### SUMMARY

An air extractor manufacturing method according to an exemplary aspect of the present disclosure includes, among other things, molding a flap in a sealed position against a housing of an air extractor. The housing has a first material composition and the flap has a second, different material composition.

Another example of the foregoing method includes molding the flap such that the flap is hingedly coupled to the housing.

Another example of the foregoing method includes molding a seal about a perimeter of the housing.

In another example of the foregoing method, the housing is molded in a first shot, the seal is then molded in a second shot, and the flap is then molded in a third shot.

In another example of the foregoing method, the seal has a material composition that is different than the first and the second material compositions.

In another example of the foregoing method, the flap is configured to passively move back and forth between the sealed position and a pressure releasing position.

In another example of the foregoing method, the flap in the sealed position permits less flow through an aperture of the housing than the flap in the pressure releasing position.

In another example of the foregoing method, the flap in the sealed position permits nominally no flow through the aperture.

In another example of the foregoing method, the flap in the sealed position directly contacts the housing at a hinged connection and directly contacts an edge of the housing. The hinged connection and the edge of the housing are on opposite sides of an opening within the housing.

In another example of the foregoing method, the flap includes an enlarged area on a first side of the housing and a primary portion of the flap on an opposite, second side of the housing.

An air extractor assembly according to another exemplary aspect of the present disclosure includes, among other things, a housing having a first material composition, and a flap having a different, second material composition. The flap is moveable relative to the housing between a sealed position and a pressure releasing position. The flap is molded in the sealed position and coupled to the housing when molded.

In another example of the foregoing assembly, the flap in the sealed position permits less flow through an aperture of the housing than the flap in the pressure releasing position.

In another example of any of the foregoing assemblies, the flap in the sealed position permits nominally no flow through the aperture.

In another example of any of the foregoing assemblies, the flap is biased toward the sealed position due to the flap being molded in the sealed position.

In another example of any of the foregoing assemblies, the flap is hingedly coupled to the housing.

Another example of any of the foregoing assemblies includes a seal about a perimeter of the housing. The seal has a material composition that is different than both the first and the second material compositions.

In another example of any of the foregoing assemblies, the seal is covalent bonded to the housing.

In another example of any of the foregoing assemblies, the flap in the sealed position includes an enlarged area on a first side of the housing and a primary portion on an opposite, second side of the housing.

In another example of any of the foregoing assemblies, the flap in the sealed position directly contacts the housing at a hinged connection and directly contacts an edge of the housing. The hinged connection and the edge of the housing are on opposite sides of an opening within the housing.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a schematic view of an air extractor in a sealed position blocking contaminants from entering a vehicle.

FIG. 2 illustrates the schematic view of FIG. 1 with the air extractor in a flow permitting position where the air extractor is permitting flow to balance a pressure in the vehicle with a pressure outside the vehicle.

FIG. 3 illustrates a front view of the air extractor of FIG. 1 in the sealed position.

FIG. 4 illustrates a section view taken at line 4-4 in FIG. 3 when the air extractor is installed within the vehicle.

FIG. 5 illustrates a front view of the air extractor of FIG. 2 in a flow permitting position.

FIG. 6 illustrates a section view taken at line 6-6 in FIG. 5 when the air extractor is installed within the vehicle.

FIGS. 7A-7C illustrate selected steps in a method of manufacturing the air extractor of FIGS. 3-6.

FIG. 8 illustrates a close-up section view of a portion of an air extractor according to another exemplary non-limiting embodiment of the present disclosure.

### DETAILED DESCRIPTION

This disclosure details an exemplary method of manufacturing an air extractor, and an air extractor manufactured by that method. Flaps of the air extractor are molded against a housing of the air extractor when the flaps are in a sealed position. Such an approach can, among other things, facilitate a consistent sealing interface between the flaps and the housing when the air extractor is in a sealing position.

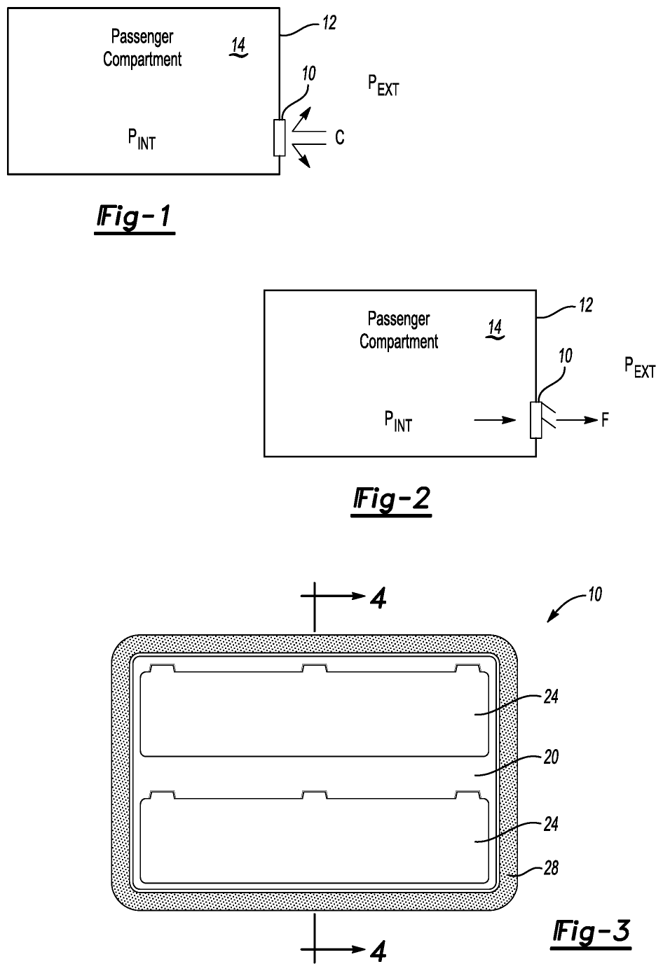

With reference to FIG. 1, a vehicle includes an air extractor 10 mounted to, for example, a vehicle body panel 12 behind a bumper or quarter panel. The air extractor 10 is shown in a sealed position where the air extractor 10 blocks a flow of contaminants C from entering an interior area of the vehicle, here a passenger compartment 14 of the vehicle. The contaminants C could include gases, such as carbon monoxide, dust, odors, etc. The air extractor 10 is in the sealed position when a pressure P_{INT} within the passenger compartment 14 is substantially equal to a pressure P_{EXT} outside the vehicle.

With reference now to FIG. 2, the pressure P_{INT} has increased to be greater than the pressure P_{EXT} such that there is a pressure differential between the interior of the vehicle and the exterior of the vehicle. The relative increase in the pressure P_{INT} could be due to an operator activating an air-conditioning system, opening a window, etc.

The pressure differential causes the air extractor 10 to move to a flow permitting position where a flow F of air from the passenger compartment 14 can move through an opening in the air extractor 10 to the exterior of the vehicle. Permitting the flow F through the air extractor 10 can lower the pressure P_{INT}. After the pressure P_{INT} is substantially equal to the pressure P_{EXT}, the air extractor 10 returns to the sealed position of FIG. 1.

With reference now to FIGS. 3-6, the example air extractor 10 includes a housing 20, at least one flap 24, and a perimeter seal 28. The example flaps 24 are hingedly coupled to the housing 20 at a hinged connection 30. The flaps 24 can pivot relative to the housing 20 about the hinged connection 30.

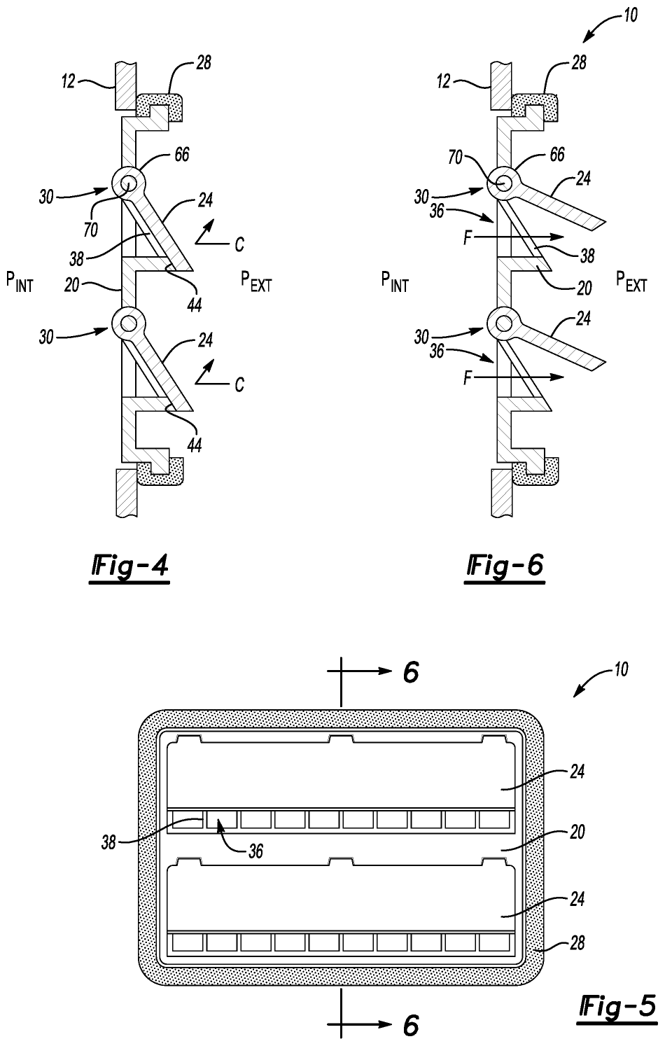

The exemplary flaps 24 are free floating and passively controlled. A rise in the pressure P_{INT} relative to the pressure P_{EXT} forces the flaps 24 to move from the sealed position of FIGS. 3 and 4 to the flow permitting position of FIGS. 5 and 6.

In this example, the seal 28 is compressed against the body panel 12 of the vehicle to block flow from moving between the body panel 12 and an outer perimeter of the air extractor 10. The perimeter seal 28 blocks such flow when the flaps 24 are in the sealed position and when the flaps 24 are in the flow permitting position.

In the position of FIGS. 5 and 6, the flaps 24 are in the flow permitting position, which permits the flow F to move from the interior of the vehicle through openings 36 within the air extractor 10 to the exterior of the vehicle. The housing 20 can include support ribs 38 spanning across selected portions of the openings 36 to strengthen the housing 20.

Due to the pressure differential, the flow F moves against the flaps 24, which causes the flaps 24 to move from the flow blocking position to the flow permitting position. When the pressure P_{INT} is substantially equal to the pressure P_{EXT}, the flaps 24 fall back to the sealed position of FIGS. 3 and 4. The flaps 24 in the sealed position directly contact portions of the housing 20 along interfaces 44.

As can be appreciated, dimensional inconsistencies in the housing 20 and the flaps 24 near the interfaces 44 could result in gaps between the housing 20 and the flaps 24 at the interfaces. Inconsistencies could include waviness in the flaps 24, flash, etc. The gaps can provide undesirable passageways for contaminants.

To address inconsistencies, the flaps 24 are molded against the housing 20 in the sealed position of FIGS. 3 and 4. Such a molding process can include injecting a molten material into a mold against the housing 20. The molten material then cures to provide the flaps 24. Molding the flaps 24 in the sealing position ensures that the interfaces 44 between the flaps 24 and the housing 20 will be relatively consistent. Thus, waviness and irregularities that could result in gaps at the interfaces 44 are avoided. Further, molding the flaps 24 in the closed position substantially biases the flaps 24 to the closed position.

When molding the flaps 24 in the sealed position each of the flaps 24 is molded such that the flaps 24 directly contacts the housing 20 at the hinged connections 30 and directly contacts an edge of the housing 20 at the interface 44. The hinged connections 30 and the edges of the housing 20 providing the interface 44 are on opposite sides of the opening 36.

To avoid the flaps 24 bonding to the housing 20 during molding, the flaps 24 have a material composition that differs from a material composition of the housing 20. The flaps 24 can thus be molded against the housing 20 in the sealing position without the flaps 24 covalent to bonding to the housing 20.

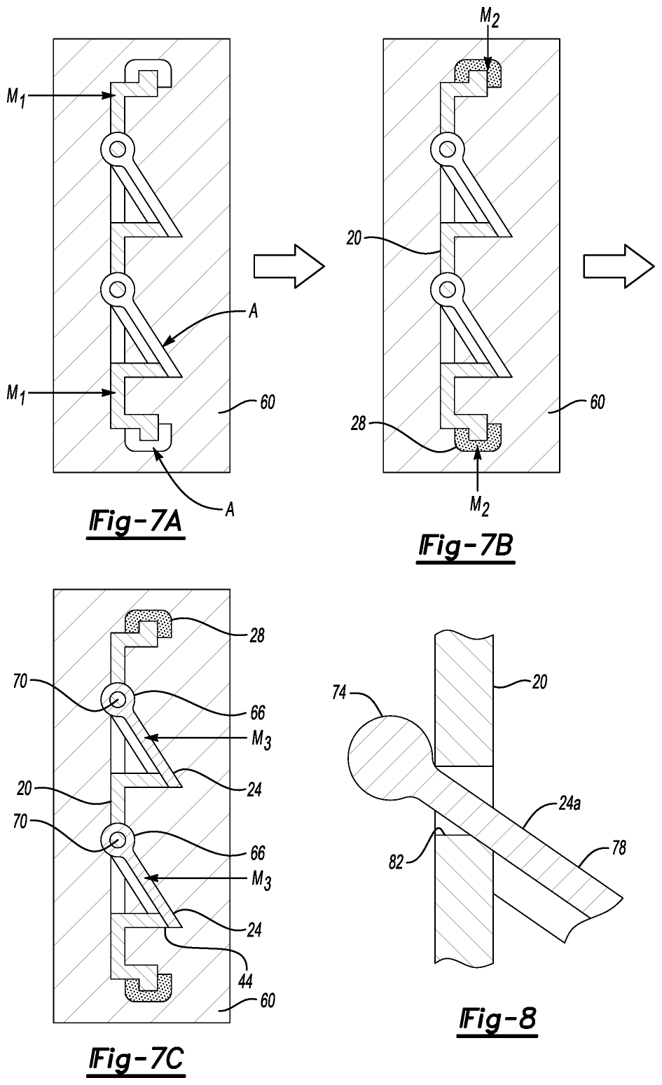

With reference now to FIGS. 7A-7C, the steps in an example air extractor manufacturing method can include positioning the housing 20 of a first material composition M₁ within a mold 60. The housing 20 does not fill areas A as these areas A will be used to form the seal 28 and the flaps 24.

The material composition M₁ is, in one example, a polymer-based material such as a thermoplastic polymer, like polypropylene, or an Olefinic Thermoplastic Elastomer (TEO). The material composition M₁ could include a talc fill, such as a 40% talc fill.

The method then moves to the step shown in FIG. 7B where a material composition M₂ is introduced to the mold 60 to provide the seal 28. The method of introduction may be part of a transfer molding method or 3-shot rotary molding process, for example.

The seal 28 has a material composition M₂ that can differ from the material composition M₁. For example, the seal 28 could be a thermoplastic elastomer (TPE) having olefins. However, unlike the flaps 24, the material composition M₂ of the seal 28 can be compatible with the material composition M₁ of the housing 20 such that the seal 28 bonds to the housing 20 as the seal 28 cures within the mold 60. In some examples, the seal 28 is covalent bonded to the housing 20 during the molding. Dipole-dipole bonds, dispersion bonds, or both could be used to secure the seal 28 to the housing 20 during molding.

Next, as shown in FIG. 7C, a material composition M₃ is injected into the mold 60 to provide the flaps 24. As shown in FIG. 7C, the flaps 24 are molded in the sealed position where the flaps 24 contact the housing 20 along the interfaces 44. The material composition M₃ of the flaps 24 is dissimilar from the material composition M₁. The material compositions M₁ and M₃ differ such that the flaps 24 do not covalent bond to the housing 20 during molding. The material composition M₃ can have a lower melt temperature than the material M₁ to inhibit the flaps 24 from bonding to the housing 20.

If, for example, a transfer molding method is used, the housing 20 can be molded outside the mold 60, and then placed within the mold 60. If, for example, a rotary molding method is used, the housing 20 can be molded in a portion of the mold 60, say, half of the mold. Next, the portion of the mold 60 and the housing 20 are rotated to a position interfacing with the remaining portions of the mold 60. The material M₃ is then injected to form the flaps 24.

In this example, the air extractor 10 includes two flaps 24. Other examples could include more flaps 24, or a single flap 24.

The flaps 24 are each hingedly connected to the housing 20 in this example. The hinged connection results from the flaps 24 including a portion 66 that circumferentially surrounds a pin 70 of the housing 20. When the flaps 24 move between the sealing position and the flow permitting position, the flaps 24 pivot about the pin 70 of the housing 20.

With reference to FIG. 8, another exemplary non-limiting embodiment could include a flap 24a molded to include an enlarged area 74 (e.g., a nub) on an opposite side of the housing 20 from a primary portion 78 of the flap 24a. The enlarged area 74 blocks the flap 24a from being withdrawn from the housing 20. The primary portion 78 blocks flow through the opening of the housing 20 when the flap 24a is in the flow blocking position.

The flap 24a can move relative to the housing 20 between the sealing position and the flow permitting position without the enlarged area 74 withdrawing through an opening 82 in the housing 20 while still permitting the flap 24a to move back and forth between a flow permitting position and a sealing position.

Features of the disclosed examples include molding a flap of an air extractor in a sealing position relative to a housing to, among other things, address waviness, flash, and other features that could introduce gaps or complicate movement of the flaps relative to the housing. The flaps are also hingedly connected to the housing during the molding, which can simplify assembly. The air extractor molded according to the disclosed examples can help to meet climate control low flow requirements for window fogging.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. An air extractor manufacturing method, comprising:
molding at least one flap in a sealed position against a housing of an air extractor, the housing having a first material composition and the at least one flap having a second, different material composition.

2. The air extractor manufacturing method of claim 1, further comprising molding the at least one flap such that the at least one flap is hingedly coupled to the housing.

3. The air extractor manufacturing method of claim 1, further comprising molding a seal about a perimeter of the housing.

4. The air extractor manufacturing method of claim 3, wherein the housing is molded in a first shot, the seal is then molded in a second shot, and the at least one flap is then molded in a third shot.

5. The air extractor manufacturing method of claim 3, wherein the seal has a material composition that is different than the first and the second material compositions.

6. The air extractor manufacturing method of claim 1, wherein the at least one flap is configured to move back and forth passively between the sealed position and a pressure releasing position.

7. The air extractor manufacturing method of claim 6, wherein the at least one flap in the sealed position permits less flow through an aperture of the housing than the at least one flap in the pressure releasing position.

8. The air extractor manufacturing method of claim 7, wherein the at least one flap in the sealed position permits nominally no flow through the aperture.

9. The air extractor manufacturing method of claim 1, wherein the at least one flap in the sealed position directly contacts the housing at a hinged connection and directly contacts an edge of the housing, the hinged connection and the edge of the housing on opposite sides of an opening within the housing.

10. The air manufacturing providing method of claim 1, wherein the at least one flap includes an enlarged area on a first side of the housing and a primary portion of the at least one flap on an opposite, second side of the housing.

11. An air extractor assembly, comprising:
a housing having a first material composition; and
at least one flap having a different, second material composition, the at least one flap moveable relative to the housing between a sealed position and a pressure releasing position, the at least one flap molded in the sealed position and coupled to the housing when molded.

12. The air extractor assembly of claim 11, wherein the at least one flap in the sealed position permits less flow through an aperture of the housing than the at least one flap in the pressure releasing position.

13. The air extractor assembly of claim 12, wherein the at least one flap in the sealed position permits nominally no flow through the aperture.

14. The air extractor assembly of claim 11, wherein the at least one flap is biased toward the sealed position due to the least one flap being molded in the sealed position.

15. The air extractor assembly of claim 11, wherein the at least one flap is hingedly coupled to the housing.

16. The air extractor assembly of claim 11, further comprising a seal about a perimeter of the housing, the seal having a material composition that is different than both the first and the second material compositions.

17. The air extractor of claim 16, wherein the seal is covalent bonded to the housing.

18. The air extractor of claim 11, wherein the at least one flap in the sealed position includes an enlarged area on a first side of the housing and a primary portion on an opposite, second side of the housing.

19. The air extractor of claim 11, wherein the at least one flap in the sealed position directly contacts the housing at a hinged connection and directly contacts an edge of the housing, the hinged connection and the edge of the housing on opposite sides of an opening within the housing.
